(19) United States
(12) Patent Application Publication
(10) Pub. No.: US 2005/0092844 A1
(43) Pub. Date: May 5, 2005

(54) Information card with multiple storage media and a device and method for reading and writing information in said card

(75) Inventors: Wei Zhang, Hong Kong (CN); Fu Zhang, Shenzhen (CN); Min Yan, Shenzhen (CN); Zhiguo Chang, Shenzhen (CN); Yingfeng Lv, Shenzhen (CN); Chengwu Gu, Shenzhen (CN); Xiaoyun Ding, Shenzhen (CN)

Correspondence Address: WOLF GREENFIELD & SACKS, PC;FEDERAL RESERVE PLAZA, 600 ATLANTIC AVENUE, BOSTON, MA, 02210-2211, US

(73) Assignee: Shenzhen Syscan Technology Co. Ltd., Shenzhen (CN)

(21) Appl. No.: 10/980,580

(22) Filed: Nov. 3, 2004

(30) Foreign Application Priority Data
Nov. 5, 2003 (CN) 2003101120680

(51) Int. Cl. G06K 15/00; G06K 19/00; G06K 19/06

(52) U.S. Cl. 235/487; 235/492; 235/493

(57) ABSTRACT

The present invention relates to an information card with multiple storage media. Combining reading and writing characteristics of magnetic strip storages, ICs, PFIDs and etc. with large storage capacity of a compound printing 2D barcode, the invention uses a base card with a magnetic strip storage medium or a base card beset with an IC read-write chip, and a RF read-write chip. On said base card contains a first 2D barcode which has different reflectivities to lights in the first spectrum area between bars and spaces, there is a designated relation between data stored in the magnetic strip or the IC chip, RF chip and data stored in the first 2D barcode. The invention discloses a read-write device of the information card comprising a Contact Image Sensor (CIS), a magnetic head or an IC chip reader, an RF chip reader. The invention further discloses a method for reading and writing data in said information card.

### 1. FIELD OF THE INVENTION

The present invention relates to an information card with multiple storage media and a device and method for reading and writing information in said card, especially relates to an information card with multiple storage media simultaneously using technologies of barcode, magnetic card, IC, and Radio Frequency Identification, and a device and method for reading and writing information in said card.

### 2. TECHNICAL BACKGROUND

Automatic identification technology, mainly including technologies of the photograph, barcode, magnetic card, IC, Radio Frequency etc., is widely applied in various fields at present, and has its advantages and disadvantages respectively.

A 2D barcode to store data using the newly compound technology has the characteristic of large storage, low cost and cannot to be modified. A data storing capacity of the 2D barcode can be greatly increased if several layers of pattern of 2D barcode are formed using different printing materials and arts in the very same area. Barcode information contained in the barcode generated in the newly printing technology cannot be completely obtained through reproduction. But because the barcode information cannot be modified, it has been restricted in some fields requiring modifying the data.

The magnetic strip storage medium has been widely used in various fields, such as bankcards, credit cards, identification cards and deposit books etc. The magnetic card is cheap but easy to wear and has a small data storing capacity generally of only several dozen bits. The magnetic strip storage medium can be modified easily and be convenient to operate. But the security level of security key of the magnetic strip is not powerful enough, and is easy to be illegally modified.

The IC chip card has a little high cost, a large data storing capacity and a high security level. However, because of the exposure of its contact, the IC chip card is easily damaged by static or manually.

The main advantage of the Radio Frequency chip card is its non-contact in using. As a result the Radio Frequency chip card doesn't require people to participate when identifying, is suitable to realize automation, and is wearproof and convenient to operate. A short distance Radio Frequency chip card is optionally used in oil, dust and other polluted environments, in which can replace barcode. For example, the short distance Radio Frequency chip card can track objects on a factory streamline. Generally, a Radio Frequency Identification (RFID) system comprises electrical labels and readers.

If independently applying various automatic identification technologies, it is no way to avoid disadvantages of those technologies themselves. For instance, the magnetic strip technology that is widely applied in the bankcard, because of its maturity and rapid read-write speed, can meet most bank applications' demand. But by the very reason of being easy to be modified and the small data storing capacity, encrypted data in magnetic strip is prone to be illegally modified, and thus results in serious loss. Nevertheless, 2D barcode has a large data storing capacity, low cost, and cannot be modified and can prevent reproduction through compound printing. But because it is unchangeable, it has been restricted in some fields requiring recording modified information.

### 3. SUMMARY OF THE INVENTION

The object of the present invention is to provide an information card with multiple storage media such as barcodes, magnetic strips, IC chips, or RF chips, and to provide an encrypted information read-write device and method for reading information stored in the card. The information stored in integrated cards of barcodes, magnetic strips, IC chips, and RF chips can be read out and decoded successfully.

The present invention provides an information card with multiple storage media and a base card attached by a magnetic strip or beset with an IC read-write chip or an RF read-write chip, wherein on said base card contains a first 2D barcode which has different reflectivities to the light in the first spectrum area between bars and spaces, there is a designated relation between data stored in the magnetic strip or the IC chip, RF chip and data stored in the first 2D barcode.

The base card of the information card in accordance with the present invention further comprises:

a second barcode which has bars and spaces transparent to the light in the first spectrum area; wherein reflectivities of the bars and the spaces of the second barcode to the light in the second spectrum area are different; the first barcode and the second barcode do not overlap or overlap partly, and there is a designated relation between data stored in the first barcode and data stored in the second 2D barcode;

a third barcode which has bars and spaces transparent to the light in the first and second spectrum area; wherein reflectivities of the bars and the spaces of the third barcode to the light in the third spectrum area are different; the first barcode, the second barcode and the third barcode do not overlap or overlap partly, and there is a designated relation between data stored in the first barcode, data stored in the second 2D barcode, and data stored in the third 2D barcode;

three or two of a magnetic strip, a RF chip or an IC chip which are located in different place or different layer, wherein data stored in different media have a designated relation; wherein the light in the first, second, and third spectrum are respectively one of an infrared ray, an ultraviolet ray, and a visible light.

The present invention also discloses a device for reading and writing information stored in an information card with multiple storage media, comprising a CIS module that scans 2D barcode, and further comprising one, two, or three of a magnetic head that reads and writes information in magnetic strip, or a reader that reads and writes information in an IC read-write chip or a RF read-write chip.

The present invention also discloses a method for reading and writing information in an information card with multiple storage media comprising a base card containing a magnetic strip or an IC read-write chip, an RF read-write chip and a 2D barcode, comprising the following steps:

reading data stored in the magnetic strip or the IC read-write chip, the RF read-write chip to obtain a symbol data and a first type of data;

scanning the 2D barcode to obtain a second type of data;

comparing the first type of data with the second type of data and determining whether the two types of data accord to a designated relation via the symbol data;

if the two types of data does not accord with the designated relationship, ending the process of read and write; otherwise, reading other information stored in the information card; and

outputting the information as required and updating data stored in the magnetic strip, IC chip, or RF chip and the symbol data.

The present invention sufficiently combines advantages of the storage of magnetic strip, erasability and wide application fields of IC, RFID and other media, and compound printing 2D barcode's large data storing capacity, not to be modified and preventing reproduction, to save information by combination of magnetic strip, IC, RFID etc. storage media and compound printing 2D barcode. In application, encrypted information and data unexpected to be modified are stored in the compound 2D barcode, and data expect to be modified are stored in the magnetic strip storage medium; also functional relation can be established between datum information on each layer of the compound printing 2D barcode and datum information in the magnetic strip storage medium, thus greatly increasing level of data encryption.

The present invention combines technologies of CIS and that of magnetic strip, IC reader and RFID reader, discloses a device for reading and writing information in the information card with multiple storage media, and a corresponding methods, such as patterns of card-sliding, paper-feeding, plate and broom-pushing, and read-write methods for the information card with multiple storage media. As existing single storage medium and corresponding read-write devices are widely applied, and data security can be greatly strengthened without changing corresponding read-write device and workflow on a large scale, such integrative application method makes card storing large quantity of data possible.

### 4. BRIEF DESCRIPTION OF THE DRAWINGS

The present invention includes drawings as follows:

FIG. 1 illustrates an example of an information card with multiple storage media in accordance with the embodiment of the present invention;

FIG. 2 is a flow chart of storing and reading information in the information card in accordance with the embodiment of the present invention;

FIG. 3 is a flow chart of encoding in accordance with the embodiment of the present invention;

FIG. 4 is a flow chart of decoding in accordance with the embodiment of the present invention;

FIG. 5 is a schematic diagram illustrating the Radio Frequency Identification Technology;

FIG. 6 illustrates an example of a slot card device;

FIG. 7 illustrates an example of a broom-pushing read-write device;

FIG. 8 illustrates an example of a paper-feeding read-write device;

FIG. 9 illustrates an example of a plate read-write device.

### 5. DETAILED DESCRIPTION OF THE PREFERRED EMBODIMENTS

In the following description, drawings and specific details are set forth in order to provide a thorough understanding of the present invention.

Here take generally applied bankcard as an example. With the development of the banking in China, bankcards have been increasingly applied. Since each bankcard is a magnetic medium, and has only two or three tracks and a small storing capacity only of several dozen bits, it is prone to be forged when the corresponding bank accounts is illegally obtained, and thus resulting in legal clients' great loss.

The present invention provides an information card that combines large storing capacity of the multi-layer printing 2D barcode to provide an information card with multiple storage media using barcode, magnetic card, IC and Radio Frequencies Identification Technologies. The present invention further provides a device and method for reading and writing information in the card. Thus the data security level is greatly increased.

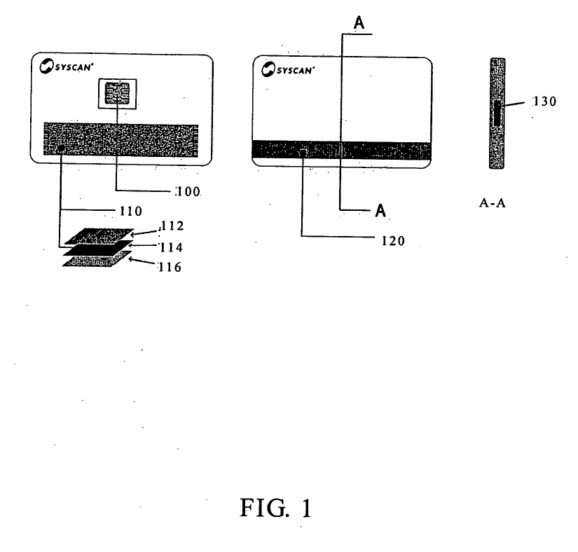

FIG. 1 is a schematic diagram of an information card with multi-storage formats according to the present invention, showing a three-dimensional layout of PVC card comprising barcode 110, magnetic strip 120, IC chip 100, and RFID chip 130. The left of the drawing shows a front planform of the PVC card, wherein the PVC card contains a barcode 110 and an IC chip 100, barcode of which is a CM 2D barcode with three layers:
Ultraviolet light readable 2D barcode layer 112, which transmit visible light and infrared light;
Visible light readable 2D barcode layer 114, which transmit infrared light;
Infrared light readable 2D barcode layer 116.

In the front side of the information card is beset with the IC chip 100 and attached the compound printing 2D barcode 110, at the back side is beset with a magnetic strip 120 with stored information, in between is beset with RFID chip 130. The base card of the information card can be a PVC card. Then it can find that the IC chip 100 and the barcode 110 aren't on the same surface as magnetic strip 120, RFID chip 130, while the IC chip 100 and the barcode 110 are on the same surface but they are located at different places.

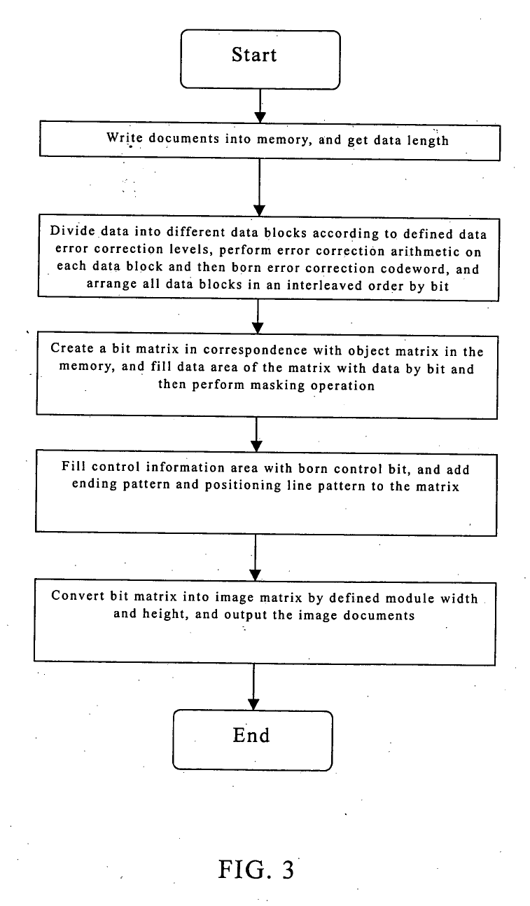

To manufacture an information card with multiple storage media, firstly encode information unexpected to be modified into the 2D compound barcode, as shown in FIG. 3. Information in the magnetic strip, IC chip and Radio Frequency Identification chip can be direct written and modified anytime. For example, encode and write the information expect to be modified during processing into the storage of RFID chip. A write device is needed to write said information into RFID chip. Through transmitting electromagnetic waves with encoded information, the write device is coupling with the RFID chip 130, and the RFID chip 130 can obtain commands and data from the write device. Processor of RFID chip 130 will write data into the memory of RFID chip 130, then the write device of IC chip will write information into the memory of IC chip 100, and that of the magnetic strip will write information into magnetic strip 120. The obtained barcode 110 is printed on the surface of base card (E.g. PVC card), the IC chip 100 with written information is beset in the base card, the magnetic strip 120 is attached on the surface of the base card, and the RFID chip 130 is embedded in the base card.

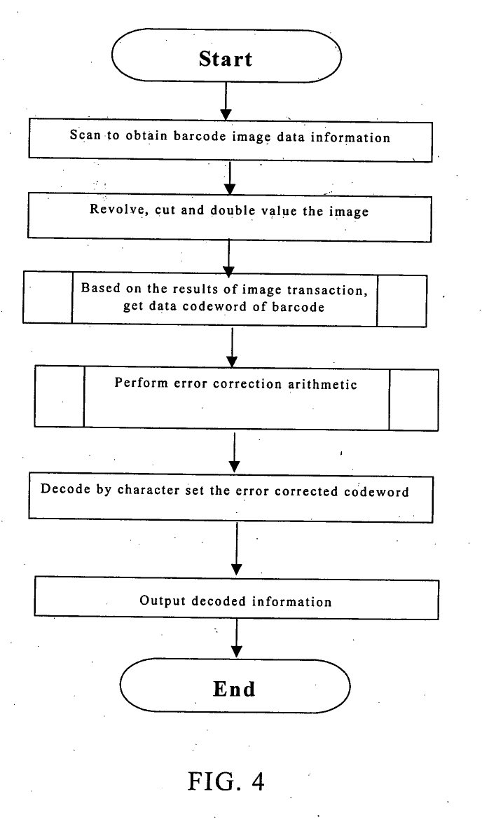

FIG. 3 shows a flow chat of the process of encoding. The process of encoding comprises the following steps: encrypting a document loaded into a memory and getting the length of the data, dividing the data into different data blocks according to defined data error correction levels, performing error correction arithmetic on each data block and then generating error correction codeword, and arranging all data blocks in an interleaved order by bit; creating a bit matrix in correspondence with an object matrix in the memory, and filling data area of the matrix with the data obtained by bit, then performing masking operation and generating control bit; filling control information area with generated control bit, and adding starting pattern, ending pattern and positioning line pattern to the matrix; converting the bit matrix into an image matrix in accordance with the width and height of the designated module and outputting the image. FIG. 4 is a flow chart of the process of decoding. The process of decoding comprises the following steps: combing the compound printing 2D barcode with the magnetic strip (i.e. on the same base card beset with the magnetic strip and attach the compound printing 2D barcode which may overlap on the magnetic strip partly or completely). When reading or writing information into the magnetic strip, the barcode doesn't conflict with it. So the magnetic strip and the barcode do not influence each other at all. The magnetic strip memory can store data expect to be changed or modified, while 2D barcode is used to store data unexpect to be changed or modified.

When storing information in different occasions, it is use one of the following combinations: the compound magnetic storage technology and visible light readable 2D barcode, magnetic storage technology and infrared light readable 2D barcode, magnetic storage technology and ultraviolet light printing 2D barcode, compound magnetic storage technology and two of three or three 2D barcode printing technology together. When reading information, information in magnetic strip can be read through an existing widely used magnetic head device, and information in compound printing 2D barcode can be read through a photoelectric barcode reader working together with a magnetic head device by different light sources and sensors.

These three kinds of 2D barcodes can contain a cipher, security key of which can be stored in the magnetic strip or IC chip or RFID chip. As scanning to decode, only security key is obtained firstly that can succeed to decode.

To print the 2D barcode on one medium, firstly print one layer of 2D barcode using printing ink that can reflect infrared light, then the second layer using printing ink that can reflect visible light but transmit infrared light, finally the third layer using printing ink that can reflect ultraviolet light and infrared light but transmit visible light. These three layers of 2D barcode can mutually or partly overlap or not overlap at all. The light reflective characteristic of each barcode printing ink can be adjusted or compounded.

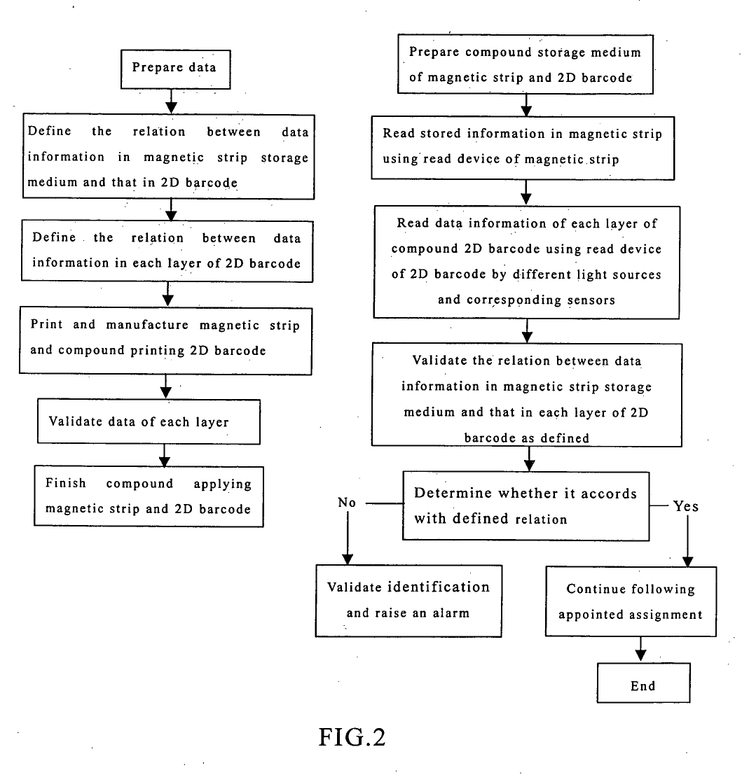

FIG. 2 is a flow chart of storing and reading of encrypted information. Take the information card composed of magnetic strip storage medium and 2D barcode for an example, in the process of storing encrypted information, the first step is to prepare storage data. The second step is to define the relation between datum information in the magnetic strip storage medium and that in the 2D barcode. Wherein the information data in 2D barcode can be encrypted, and the corresponding security key can be stored in the magnetic strip storage medium. The third step is to define the relation between the datum information in each layer of 2D barcode. Such relation can be a functional relation or the upper layer of barcode stores the decoding security key of the lower layer of barcode, and the lower barcode can be read out until the upper layer of barcode has been decoded successfully. The fourth step is to manufacture magnetic strip and compound printing 2D barcode. And the fifth step is to validate data of each layer according to defined relation.

The configuration of the relation between the data can be as following: converting a second type of data that does not expect to be modified as a 2D barcode, and converting a first type of data that expect to be modified frequently and the second type of data to a symbol data in accordance with a designated mathematic formula. Then write the first type of data and the symbol data into the magnetic strip, IC chip, or RFID chip. The symbol data are updated as the data is updated.

The corresponding read and write process comprises the following steps: reading data from the magnetic strip, IC chip, or RF chip and dividing the first type of data from the read data; scanning and decoding the second type of data stored in the 2D barcode; comparing the first type of data with the second type of data and checking whether the two types of data accord with a designated relationship with the symbol data. If the two types of data do not accord with the designated relationship, the process of read and write ends. Otherwise, other data stored in the information card are read. The process further comprises the step of outputting the read data and updating data stored in the magnetic strip, IC chip, or RF chip and the symbol data.

The process of reading encrypted information comprises following steps. The first step is to prepare the compound storage medium of magnetic strip and 2D barcode. The second step is to read the information stored in magnetic strip using a read device of magnetic strip. The third step is to read datum information in each layer of compound 2D barcode using a read device of 2D barcode by different light sources and corresponding sensors. The forth step is to validate the relation between datum information in the magnetic strip storage medium and that in each layer of 2D barcode as defined. The fifth step is to validate identification and raise an alarm, if not accord with defined relation; otherwise continue following appointed assignment.

Through making over an existing bankcard, the present invention can be used in the existing bankcard, it can be realized. Thus, it can change original storage of several dozen bits of magnetic strip to data storing capacity of several thousand bits of compound 2D barcode, correspondingly increasing the level of encryption security and security key.

FIG. 3 and FIG. 4 are the processes of encoding and decoding of 2D barcode respectively. The decoding process includes the following steps: (a) scanning to obtain the barcode image datum information; (b) revolving, cutting and doubling value the image; (c) based on the results of image transaction, getting the data codeword of barcode; (d) correcting the codeword using error correction arithmetic and decoding the corrected codeword; (e) outputting decoded information.

A read device of the information card for storing information with multiple storage media according to the present invention employs a CIS (Contact Image Sensor) module that can scan compound 2D barcode. The sensor contains an infrared light source, a visible light source and an ultraviolet light source. During scanning, the three different light sources work time-sharing and equably illuminate the compound barcode. The CIS module also has a photoelectric sensor for receiving reflected light by compound 2D barcode through column lens and then converting into electrical signals and sending to external circuit. When the infrared light source works, the barcode layer that reflects the infrared light in the compound 2D barcode is read out and converted into electrical signals containing a first part of corresponding information of the barcode for decoding. When the visible light source works, the barcode layer that reflects visible light in the compound 2D barcode is read out and converted into electrical signals containing a second part of corresponding information of the barcode for decoding. When the ultraviolet source works, the barcode layer that reflects ultraviolet light in the compound 2D barcode is read out and converted into electrical signals containing a third part of corresponding information of the barcode for decoding. The CIS module also comprises a line photoelectric sensor or a surface photoelectric sensor scanning at the direction perpendicular to the slot.

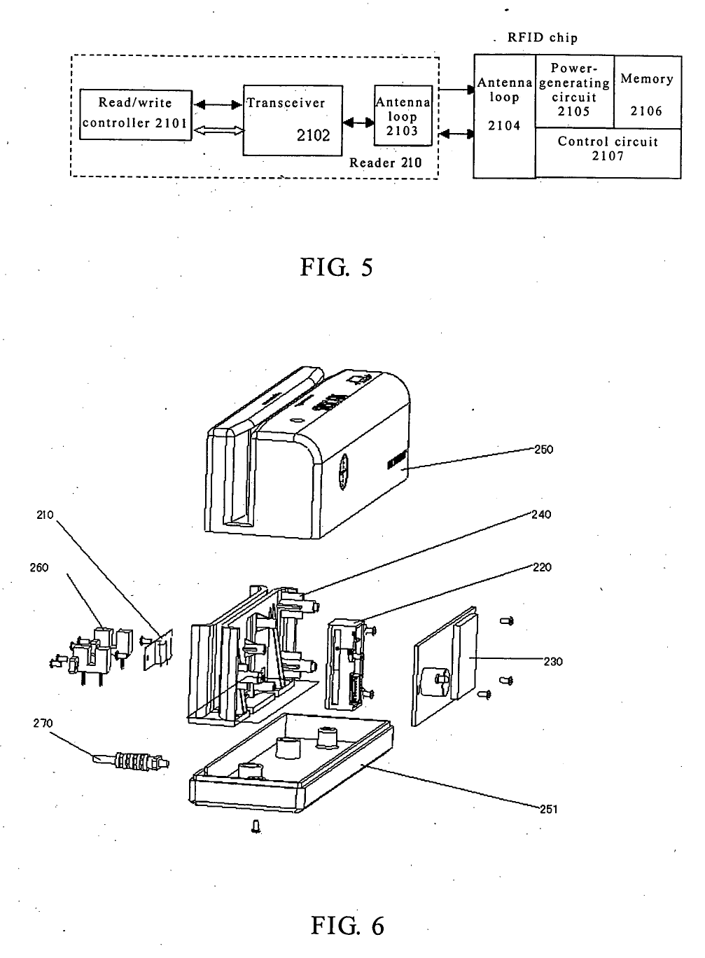

FIG. 5 illustrates a schematic diagram of Radio Frequency Identification system. The circuit for identifying the Radio Frequency comprises two parts: a RFID chip embedded in the objects to be identified (i.e. a RF read-write card), and a reader for reading information stored in the RFID chip.

The RFID chip comprises an antenna loop 2104, a power-generating circuit 2105, a memory 2106 and a control circuit 2107 that cooperate to work. The storage 2106 is an erasable device such as an EEPROM or a Flash. The information card with multiple storage media according to the present invention is beset with such RFID chip.

The reader comprises a read-write controller 2101, a transceiver 2102 that is controlled by the read-write controller 2101 and exchanges data with the read-write controller 2101, and an antenna loop 2103 that is connected to the transceiver 2102 to trans-receive information; a read-write controller 2101 on which exists communication interface connecting to the external mainframe. The read-write device according to the present invention uses such reader to read, and update information stored in the RFID chip.

FIG. 6 illustrates a structure sketch map of the slot card device according to the present invention, comprising a reader 210, an image sensor module 220, a PCB 230, a body 240, a top cover 250, a bottom cover 251, a switch 260 and a cable 270. The reader 210 can be a RF (Radio Frequency) reader that reads RF chips, an IC chip reader that reads IC chips, or a magnetic heads that reads information on magnetic strips. The switch 260 can either be a photoelectric switch or a mechanical switch.

The PCB 230 is screwed on the body 240, and the cable 270 is connected to corresponding output interface of PCB 230. The reader 210 and the image sensor module 220 are screwed on a corresponding positioning hole of body 240, and convert magnetic signal and light signal into data signal through the PCB 230, and transmit externally via the cable 270. The body 240 is screwed on a corresponding positioning hole of bottom cover 251. The top cover 250 is fastened upon the bottom cover 251. The switch 260 is screw on a corresponding positioning hole of body 240. When the card passes the brushing slot of body 240, the switch 260 will trigger the image sensor module 220 and the reader 210 by the PCB 230 to get corresponding data signal in the information card.

If the reader 210 is an IC chip reader, when the card passes the slot of body 240, the switch 260 will lock it. Now the IC chip on the card electrically contacts the IC chip reader 210 through which reads information in the IC chip. If reading out successfully, an LED indicator on the PCB 230 will flash, and a buzzer on it will make a sound indicating the user to continue to slot card. Meanwhile the switch 260 will loosen and trigger the image sensor module 220 by the PCB 230 to obtain barcode signal.

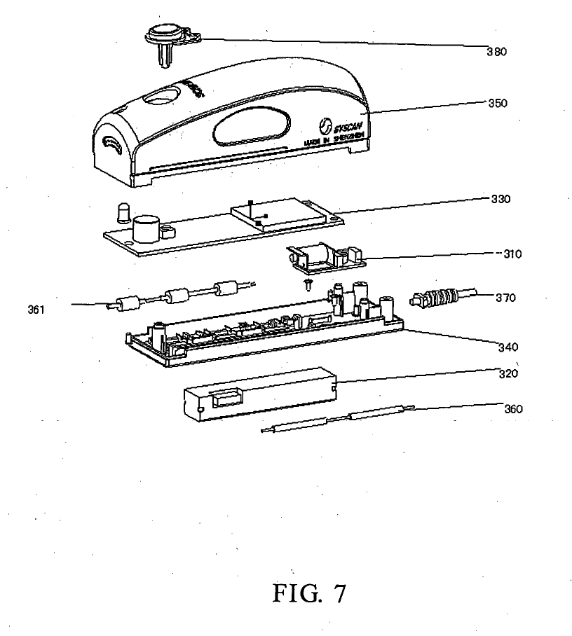

FIG. 7 shows a sketch map of broom-pushing read-write device according to the present invention, comprising a reader 310, an image sensor module 320, a PCB 330, a body 340, a top cover 350, a first roller 360, a second roller 361, a cable 370 and a button 380. Wherein the reader 310 can be a RF reader that reads RF chip, an IC chip reader that reads IC chip or a magnetic head that reads information on magnetic strip.

The reader 310 and the image senor module 320 are screwed on a corresponding positioning hole of body 340. The PCB 330 is screwed on the body 340, converts magnetic signals and light signals into datum signals, and transmits externally through the cable 370 that is fastened upon a corresponding data output interface of PCB 330.

The button 380 is fastened upon the top cover 350. Press button 380, move read-write device and then start to scan. The first roller 360 and the second roller 361 are coupled on the body 340 to ensure card-sliding track is straight, the top cover 350 is fastened on the body 340.

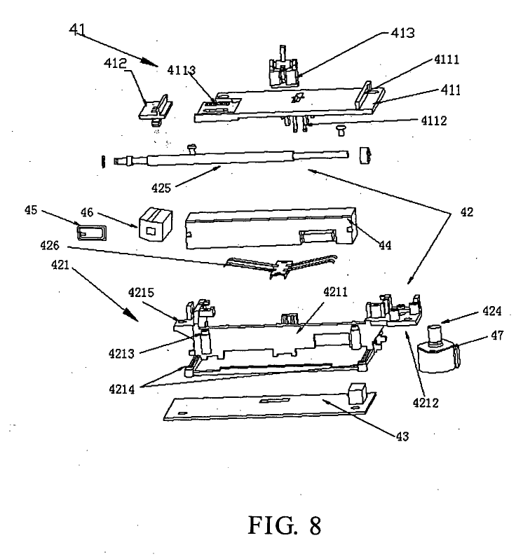

FIG. 8 illustrates a sketch map of disassembling structure of the paper-feeding read-write device according to the present invention, comprising a feed device 41, a drive machine 42, a circuit board 43, an optical scanning element 44, a RFID transmitting loop 45, a magnetic head 46, a step-advance motor 47.

Wherein the paper-feeding device 41 comprises a feed plate 411, a slot block 412 and an induction switch 413 equipped on the feed plate 411, and said component compose a feed console. On the feed plate 411 there is a flange 4111 used as a feed positioning line, a clip fastening structure 4112 for fixing the induction switch, and feed trough 4113 for guiding the slot block 412.

The drive machine 42 comprises a supporting shelf 421, a decelerating gear group 424, a roller 425, and a supporting spring patch 426. The supporting shelf 421 can be divided into: a supporting part of an optical scanning element 4211, that of driver 4212, that of feed plate 4213, that of circuit board 4214, and coupling hole 4215 for connecting main system.

The circuit board 43 is equipped with an electrical elements used for decoding, scanning, identifying, controlling and driving, screwed to the supporting shelf 421, connected to an optical scanning element 44, a RFID transmitting loop 45, a magnetic head 46 and a step-advance motor by cable, for supplying power and transmitting signals.

The optical scanning element 44 converts images into electrical information, fixed upon the sensitive supporting element 4211.

The magnetic head 42 is fixed on one side of the feed plate. The upper face of the magnetic head 42 is on the same plane of the feed plate. When the magnetic card moves along the feed plate, the magnetic head will convert magnetic change into electrical signals.

The RFID transmitting loop 45 is fixed under one side of the feed plate 411 for generating a fast changing electromagnetic field, near which a RFID chip induces electricity, and will drive the chip.

The step-advance motor 47 drives the roller 425 to rotate through a decelerating gear group 424 and the information card with multiple storage media to move horizontally, and then read out the magnetic strip information, compound 2D barcode information and RFID information stored in the information card respectively.

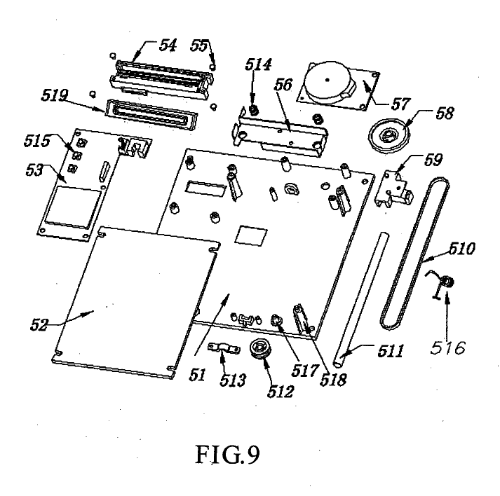

FIG. 9 illustrates a sketch map of disassembling structure of the plate read-write device according to the present invention, which comprises a base 51, a drive machine 52, a photoelectric Radio Frequency inductor, and a circuit board 53.

Wherein the drive machine 52 comprises a motor 57, a gear 58, a shaft 511, a belt wheel 512, a teeth-shape belt 520, a tightening spring 516, a slot block 59, a fixing shelf 513, a photoelectric Radio Frequency inductor shelf 56, and two springs 514.

The photoelectric Radio Frequency inductor comprises an integrated optical scanning element 54 and a RFID transmitting loop 519.

The gear 58 is geared to motor 57's gear. The motor is screwed upon corresponding position of the base. The fixing shelf 513, cooperated by a shelf, screws the shaft on the base. The belt wheel 512 is fixed on a fixing shaft 517. The teeth-shaped belt 510 is used to connect the gear 58 with the belt wheel 512. The tightening spring 516 is fixed on the teeth-shaped belt 510 for tightening and making the teeth-shaped belt 510 elastic. The slot block 59 is fixed moveable on the shaft 511, and geared to teeth-shaped belt 510 and glued by soft colloid. The photoelectric Radio Frequency inductor shelf 56 is screwed on the slot block 59, on which glued two springs 514. The supporting pole 55 is fixed in pre-saved hole of the optical scanning element 54. The glass 52 is equipped upon the positioning pole 518 of base.

The optical scanning element 54 is a sensor element for converting images into electrical information.

The RFID transmitting loop is used to generate a fast changing electromagnetic field, near which a RFID chip induces electricity, and will drive the chip.

The circuit board 53 is equipped with electrical elements used for decoding, scanning, identifying, controlling and driving, screwed to the base, and connected to the optical scanning element 54, the RFID transmitting loop 519, and the step-advance motor by cable, for supplying power and transmitting signals.

1. An information card with multiple storage media using a base card attached by a magnetic strip or beset with an IC read-write chip or an RF read-write chip, wherein on said base card contains a first 2D barcode which has different reflectivities to the light in the first spectrum area between bars and spaces, there is a designated relation between data stored in the magnetic strip or the IC chip, RF chip and data stored in the first 2D barcode.

2. The information card with multiple storage media as claimed in claim 1, wherein the base card further contains a second barcode which has bars and spaces transparent to the light in the first spectrum area; reflectivities of the bars and the spaces of the second barcode to the light in the second spectrum area are different; the first barcode and the second barcode do not overlap or overlap partly, and there is a designated relation between data stored in the first barcode and data stored in the second 2D barcode.

3. The information card with multiple storage media as claimed in claim 2, wherein the base card further contains a third barcode which has bars and spaces transparent to the light in the first and second spectrum area; reflectivities of the bars and the spaces of the third barcode to the light in the third spectrum area are different; the first barcode, the second barcode and the third barcode do not overlap or overlap partly, and there is a designated relation between data stored in the first barcode, data stored in the second 2D barcode, and data stored in the third 2D barcode.

4. The information card with multiple storage media as claimed in claim 2, wherein said base card contains three or two of a magnetic strip, a RF chip or an IC chip which are located in different place or different layer, and data stored in different media have a designated relation.

5. The information card with multiple storage media as claimed in claim 3, wherein the light in the first, second, and third spectrum are respectively one of an infrared ray, an ultraviolet ray, and a visible light.

6. A device for reading and writing information stored in an information card with multiple storage media, comprising a CIS module that scans 2D barcode, and further comprising one, two or three of a magnetic head that reads and writes information in magnetic strip, or a reader that reads and writes information in an IC read-write chip or a RF read-write chip.

7. The device as claimed in claim 6, further comprising a shelf that contains a slot, a circuit board, and a switch used for reader of IC read-write chip, wherein the magnetic head, the reader for reading information in the IC chip, the reader for reading information in the RF chip and the switch are placed on the sidewall of the slot and electrically connected to the circuit board; the CIS module is fixed on one side of the shelf and electrically connected to the switch and the circuit board.

8. The device as claimed in claim 6, further comprising a body 340, a circuit board 330, a first trolley 360 and a second trolley 361, wherein said CIS module, magnetic head and reader for reading information in the IC chip, the reader for reading information in the RF chip are electrically connected to the circuit board 330 and fixed on the body 340, and windows for reading and writing are respectively located at one side of the information card; the first trolley 360 and the second trolley 361 are coupled on the body 340 and located parallel on each side of the CIS module.

9. The device as claimed in claim 6, further comprising a paper-feeding device 41, a drive machine 42 and a circuit board 43, wherein the paper-feeding device 41 connects to the drive machine 42 to drive the information card slide across scanning window of the CIS module; the magnetic head reader is fixed on the paper-feeding device 41, upper side of which is on a same plane of the feed plate; the reader that reads RF read-write chip is fixed on the paper-feeding device 41; the CIS module, magnetic head that reads and writes data in the magnetic strip and reader that reads RF read-write chip are electrically connected to the circuit board 43.

10. The device as claimed in claim 6, further comprising a base 51, a drive scanning device, a transparent plate 52 above the CIS module and a circuit board 53 for electronically connecting above modules fixed on the base 51; wherein the reader for reading data stored in the RF chip is fixed on the CIS module; the drive scanning device drives the CIS module move along the transparent plate 52.

11. A method for reading and writing information in an information card with multiple storage media comprising a base card containing a magnetic strip or an IC read-write chip, an RF read-write chip and a 2D barcode, comprising the following steps:
reading data stored in the magnetic strip or the IC read-write chip, the RF read-write chip to obtain a symbol data and a first type of data;
scanning the 2D barcode to obtain a second type of data;
comparing the first type of data with the second type of data and determining whether the two types of data accord to a designated relation via the symbol data; and
if the two types of data does not accord with the designated relationship, ending the process of read and write; otherwise, updating data stored in the magnetic strip, IC chip, or RF chip and the symbol data.
